(19) United States
(12) Patent Application Publication
(10) Pub. No.: US 2002/0021080 A1
(43) Pub. Date: Feb. 21, 2002

(54) Display apparatus and method for producing same

(76) Inventors: Yoshihiro Kanno, Gifu (JP); Yoichi Morita, Gifu (JP); Masatake Hayashi, Gifu (JP); Hirohito Komatsu, Kanagawa (JP); Kiyoshi Okano, Gifu (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/844,318

(22) Filed: Apr. 27, 2001

(30) Foreign Application Priority Data
Apr. 28, 2000 (JP) P2000-130691

(51) Int. Cl. H01J 1/62

(52) U.S. Cl. 313/494

(57) ABSTRACT

A display apparatus includes a pair of substrates connected to each other via a pre-set gap for delimiting a hermetically sealed space, an ionizable gas charged into this space, and discharging electrodes formed at least on one of the substrates to incur discharge in the space. The discharging electrodes are coated with a protective skin film formed by the electro-deposition method. The protective skin film is an electro-deposited and sintered mixture of boride or carbon containing electrically conductive powders and glass powders. In electro-deposition, the mean particle size of the electrically conductive powders and the glass powders is not larger than 10 μm or in a range from 1 to 3 μm. The electrically conductive powders and the glass powders are mixed in a volumetric ratio in a range from 9:1 to 3:7, with the film thickness of the protective skin film being in a range from 1 to 20 μm. This enables suppression of deterioration of the discharging electrodes with lapse of time, while enabling the lowering of the discharge voltage.

### BACKGROUND OF THE INVENTION

1. Field of the Invention

This invention relates to flat panel type display apparatus exploiting plasma discharge and a method for producing the same. More particularly, it relates to a protective structure for a discharging electrode.

2. Description of Related Art

A display apparatus of a flat panel structure, exploiting plasma discharge, includes a pair of substrates joined to each other via a pre-set gap to form a hermetically sealed space in-between, an ionizable gas charged into this space, and electrodes formed at least on one of the substrates to ionize the gas to induce discharge in the space delimited between the paired substrates. In a display apparatus exploiting DC gas discharging, the electrodes operate as an anode and a cathode. A partitioning wall may occasionally be provided for separating the plural electrodes formed on the substrates in order to define the space of the paired substrates. Specified examples of the display apparatus exploiting the DC type gas discharge include a plasma display panel (PDP) and a plasma addressed liquid crystal (PALC). In these display apparatus, Ni or Al, mainly furnished as printing paste, were used as a cathode side electrode material.

However, these electrode materials suffer from the following drawbacks. The first problem is anti-sputtering characteristics and discharging voltage. A conventional DC type cathode material undergoes severe attrition and deterioration due to plasma discharge to affect the useful life of the display device. Specifically, the cathode electrode is low in anti-sputtering characteristics such that the electrode material flies to and is deposited on the panel glass to lower the transmission ratio. The electrode material itself is subjected to attrition and deterioration to induce abnormal discharging. In addition, materials such as Ni or Al are higher in work function, so that the discharging voltage tends to be increased, thus similarly affecting the useful life of the display panel. In order to cope with these drawbacks, Hg is conventionally added to a discharging gas if Ni is used. On the other hand, if Al is used as an electrode material, a current-limiting resistor is inserted in each discharge cell in order to limit the excess discharging current.

With a view to using voltage driving for improving anti-sputtering characteristics of the electrode, attempts have been made to coat the electrode surface with a material exhibiting a low work function. In general, film-forming by a printing method has advantages that it is inexpensive and superior in mass-productivity. However, insofar as the manufacturing process is concerned, it is necessary to provide a sintering process in an oxidizing atmosphere comprising sintering a paste during the process after firing off a binder resin material contained in the paste. For example, in a DC type PDP, borides, such as LaB₆ or GdB₆, as low work function materials, have been tentatively used as an electrode coating material. However, these borides are surface-oxidized by the sintering process, such that sufficiently useful characteristics cannot be achieved.

With a view to employing voltage driving for improving anti-sputtering characteristics of an electrode, the Japanese Laying-Open Patent H-9-311647 or the Japanese Laying-Open Patent H-11-237851 discloses a technique of coating the electrode surface with a low work function material by an electro-deposition method which takes the place of the printing method. However, as for the manufacturing process, there is required a sintering process of sintering a paste in an oxidizing atmosphere after burning off a binder resin material contained in a paste during the manufacturing steps. This unavoidably oxidizes the electrode and the low work function material used for coating the electrode. Up to now, borides, such as LaB₆ or GdB₆, as the low work function materials, have been tentatively used for a DC type PDP. However, these borides are surface-oxidized due to the firing process, such that properties of these materials cannot be exploited sufficiently.

The technique of coating the electrode surface with a low work function material by an electro-deposition method instead of by the printing method, with a view to low voltage driving for improving anti-sputtering properties of the electrodes, is disclosed in, for example, the Japanese Laying-Open Patent H-9-311647 or in Japanese Laying-Open Patent H-11-237851. However, the conditions so far used in electro-depositing borides, such as LaB₆ or GdB₆, as a coating material for discharging electrodes, are not necessarily optimum, thus representing a problem which should be

### SUMMARY OF THE INVENTION

The present invention provides a display apparatus including a pair of substrates connected to each other via a pre-set gap for delimiting a hermetically sealed space therebetween, an ionizable gas charged into this space, and discharging electrodes formed at least on one of the substrates to incur discharge in the space. The discharging electrodes are coated with a protective skin film formed by the electro-deposition: method. The protective skin film is an electro-deposited and sintered mixture of boride or carbon containing electrically conductive powders and glass powders. In this display apparatus, the protective skin film is electro-deposited by a suspension formed on dispersing the electrically conductive powders and the glass powders in a solvent and also on dissolving an ionic material therein. The mean particle size of the electrically conductive powders and the glass powders is not larger than 10 μm or in a range from 1 to 3 μm. The electrically conductive powders and the glass powders are mixed in a volumetric ratio in a range from 9:1 to 3:7, with the film thickness of the protective skin film being in a range from 1 to 20 μm.

According to the present invention, an electro-deposition method (electrophoretic method) is used for forming an overcoat effective for an electrode for plasma discharge. For optimizing the conditions for electro-deposition, the mean particle size of the electrically conductive powders and the glass powders is not larger than 10 μm or in a range from 1 to 3 μm. The electrically conductive powders and the glass powders are mixed in a volumetric ratio in a range from 9:1 to 3:7, with the film thickness of the protective skin film being in a range from 1 to 20 μm. In the electro-deposition method, since an overcoat can be applied after firing the discharging electrodes and the partitions, oxidation of the electrode material can be evaded as much as possible. The electrode material is nickel or aluminum, as routine materials, formed on printing or plating. The overcoat material is borides or carbon having superior anti-sputtering characteristics and a lower work function. That is, the overcoat material is an electro-deposited and sintered mixture of boride or carbon containing electrically conductive powders and glass powders. By using this protective skin film, the discharging electrodes can be prevented from being deteriorated with lapse of time, while the discharging voltage can be lowered so that addition of a mercury vapor to the discharge gases, required in the conventional practice, can be dispensed with. In order to enable plasma discharge, despite overcoating of the discharging electrode, the overcoating material used is borides or carbon having the high secondary electron emitting characteristics as described above. The measure of the secondary electron emitting characteristics. The lower the work function, the higher become the secondary electron emitting characteristics and the more stable the plasma discharge that can be maintained.

According to the present invention, the boride exhibiting superior anti-sputtering characteristics and a low work function is coated on the electrode surface by an electro-deposition method under an optimum operating condition as simplicity and inexpensiveness of the discharging electrode formed by the printing method or by the plating method is maintained. As the electrode material, nickel or aluminum, as routine electrode material, is used and, as the material for the electro-deposited film, borides or carbon, having superior anti-sputtering characteristics and a low work function, is used. This renders it possible to suppress deterioration of the discharging electrodes with lapse of time and to lower the discharge voltage.

### BRIEF DESCRIPTION OF THE DRAWINGS

FIG. 1 is a schematic cross-sectional view showing a display apparatus according to the present invention.

FIGS. 2A to 2D show respective steps for preparation of the display apparatus according to the present invention.

FIG. 3 is a schematic view showing an electro-deposition tank used in the method of the present invention.

FIG. 4 is a schematic view for explaining the operation of a display apparatus according to the present invention.

### DESCRIPTION OF THE PREFERRED EMBODIMENTS

Referring to the drawings, preferred embodiments of according to the present invention will be explained in detail.

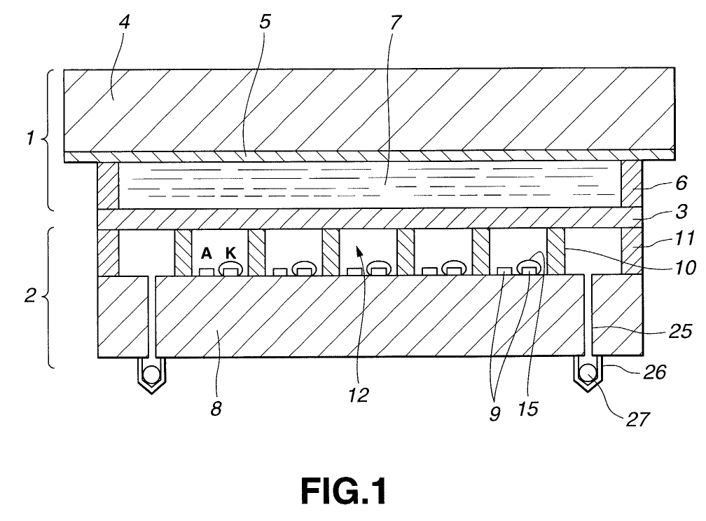

A plasma address display apparatus according to an embodiment of the present invention is shown in FIG. 1 and has a flat panel structure comprised of a display cell 1, a plasma cell 2 and a common intermediate substrate 3. The plasma cell 2 is made up of a lower substrate 8 bonded to the intermediate substrate 3. In-between the plasma cell 2 and the intermediate substrate 3 is sealed an inert gas, such as ionizable gas. On an inner surface of the lower substrate 8 are formed striped discharging electrodes 9. Since the discharging electrodes 9 are hot-printed on the flat substrate 8 by e.g., a screen printing method, the discharging electrodes 9 are not only superior in productivity and workability but cam be miniaturized. The discharging electrodes 9 may also be formed by a plating method, using e.g., nickel as a material, in place of by the printing method. As the plating method, an electrolytic plating or the electroless plating may be used. If the electrolytic plating is used, aluminum or nickel is formed to a thickness of the order of 0.2 μm by e.g., sputtering and nickel is plated thereon to a thickness of 5 μm to prepare a desired thick film electrode. Every two discharging a electrodes 9 are separated by one partition 10, which divides the space charged with the ionizable gas to delimit a discharging channel 12. The partition can also be prepared by hot printing by a screen printing method and has its top compressing against the lower surface of the intermediate substrate 3. A pair of discharging electrodes 9 surrounded by two neighboring partitions 10 operate as an anode A and a cathode K, across which plasma discharging occurs. The intermediate substrate 3 and the lower substrate 8 are joined to each other by a sealant 11, such as glass frit.

The display cell 1 is formed by a transparent upper substrate 4 which is bonded to the intermediate substrate 3, such as with an adhesive 6, with a pre-set gap in between. Within this gas is charged an electro-optical substance 7, such as liquid crystal. On the inner surface of the upper substrate 4 are formed a plurality of signal electrodes 5 extending at right angles to the striped discharging electrodes 9 . The intersections of the signal electrodes 5 and the discharging channel 12 define matrix-shaped pixels.

In this plasma addressed display apparatus, respective rows of the discharging channel 12, in which plasma discharging occurs, are scanned line-sequentially in a switching fashion. In synchronism with this scanning, picture signals are applied to the columns of the signal electrodes 5 on the display cell 1 to effect display driving. When plasma discharging occurs in the discharging channel 12, the inner space is substantially at an anode potential such that pixels are selected on the row-by-row basis. That is the discharging channel 12 operate as sampling switches. If picture signals are applied to the respective pixels as the plasma sampling switches are turned on, sampling occurs such as to control turning on or off of pixels. The picture signals are held as they are in the pixels even after the plasma sampling switches are turned off.

As characteristic of the present invention, each discharging electrode 9 operating as the cathode K is coated with an electro-deposited film 15. This electro-deposited film 15, operating as a protective skin film, is a mixture of boride- or carbon-containing electrically conductive powders, and low melting glass powders, electro-deposited and sintered together. Specifically, the electro-deposited film 15 is formed of a suspension obtained on dispersing electrically conductive powders and glass powders in a solvent and on dissolving ions therein. The boride and glass powders are prepared to a mean particle size not larger than 10 μm. The boride and glass powders are preferably as close in particle size as possible to each other and are formed to have a particle size range from 1 to 3 μm. On the other hand, the boride and glass powders are mixed together to a volumetric size range of 9:1 to 3:7. The thickness of the electro-deposited film 15 is controlled to be in a range from 1 to 20 μm

In the embodiment shown in FIG.1, the inner space of the plasma cell 2 is evacuated through an exhaust tube 25 opened in the lower substrate 8 and a glass chip tube 26 communicating therewith, and is subsequently charged with an ionizable gas. The glass chip tube 26 then is sealed off. A getter retained in the inside of the glass chip tube 26 is heated to absorb unneeded gases other than the ionizable gas. In addition to the getter, a minor amount of mercury may be retained in the inside of the glass chip tube 26 and heated to charge a mercury vapor in the inner space of the plasma cell 2. In general, the mercury vapor is introduced to prevent deterioration of the discharging electrodes 9 due to sputtering. In the present invention, in which the discharging electrodes 9 are coated with the electro-deposited-film 15 having superior anti-sputtering properties, no mercury vapor possibly needs to be introduced. However, the mercury vapor may be introduced for further improving the anti-sputtering properties. However, even in such case, the amount of the mercury vapor may be smaller than in a conventional system. Stated differently, the substance that makes up the electro-deposited film 15 exhibits anti-sputtering properties sufficient to eliminating the necessity of using the mercury or to reduce the amount of the mercury used.

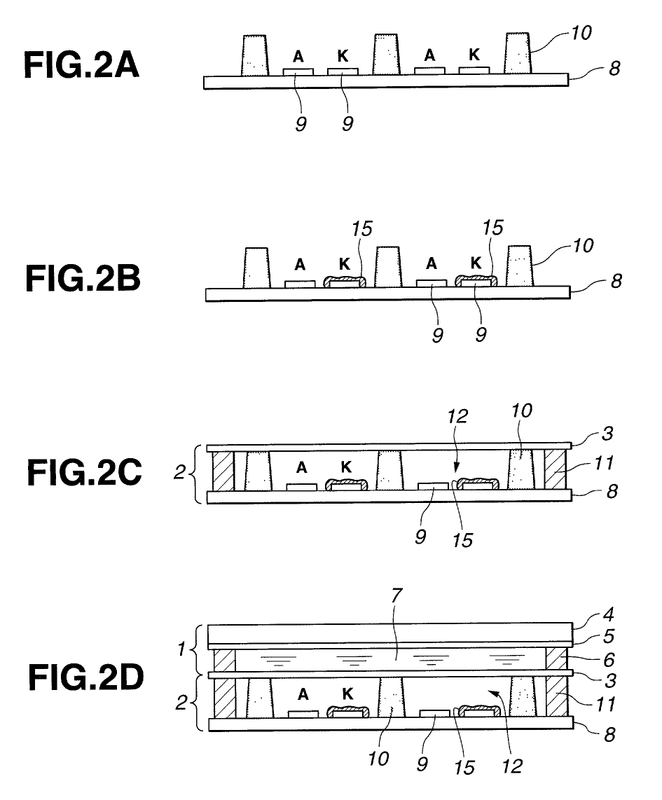

FIGS.2A to 2D are process diagrams showing the manufacturing method of the display apparatus according to the present invention. First, Referring to FIG.2A, the discharging electrodes 9, which prove the anode A and the cathode K, are formed on the rinsed lower substrate 8. In the present embodiment, the discharging electrodes 9 are 40 μm in thickness and 100 to 300 μm in width, depending on device designing. The electrodes are formed of a nickel paste by a printing method. The sandblasting method may also be used for improving an aperture ratio. In this case, an electrically conductive paste is hot-printed at the outset on the lower substrate 8 and selectively ground through a precision mask to produce striped discharging electrodes 9. If the printing method is used, the lower substrate 8 is dried for vaporizing the solvent off after printing and subsequently provisionally fired for removing unneeded binder resins. The resulting substrate is then fired to melt the glass particles for immobilizing nickel particles in the dried paste. The heating temperature at this time reaches 500 to 600° C. After forming the discharging electrodes 9, the partitions 10 are formed by the glass paste, again by the printing method. Then, terminal electrodes for connection, not shown, are formed by the printing method. The partitions 10, terminal electrodes etc., may also be formed in a lump along with the discharging electrodes 9.

Then, as shown in FIG.2B, the electro-deposited film 15, operating as a protective skin film of the discharging electrode 9, is formed to cover at least the cathode 15 completely. The electro-deposited film 15 is formed of a material selected from the group of borides and carbon as electrically conductive powders. An electro-deposition solution, used for electro-deposition, is a suspension obtained on adding powders of a material desired to be deposited or low-melting glass powders, operating as a binder, to e.g., isopropyl alcohol, as a solvent, and also mixing e.g., Mg ions for affording electrical charges to the powders.

In the present embodiment, isopropyl alcohol is used as a solvent, powders of GdB₆ and low-melting glass powders at a ratio of 1:1, and an aqueous solution of magnesium oxalate is added to the resulting mixture to prepare a suspension for electro-deposition. The mean particle size of the GdB₆ powders is 3.1 μm, with the mean particle size of the low-melting glass powders being 1.5 μm. As the low-melting glass material, alkali glass or lead glass is used. The liquid suspension, thus prepared, is charged into an electro-deposition device comprised of an electrically conductive polypropylene vessel. The substrate 8, now carrying the discharging electrodes 9 or the partitions 10, is immersed in the electro-deposition device. At this time, a negative electrode of a power source is connected to an electrode forming the electro-deposited film 15, herein the cathode K, and an electrical voltage is applied across the negative electrode and the counter-electrode, herein the anode, formed e.g., of stainless steel, and on which is formed the electro-deposited film 15. The applied voltage ranges from to 10 to 50V. An optimum voltage needs to be selected because the rate of deposition of the electro-deposited film 15 or the particle size distribution differs with the applied voltage. When the voltage is applied across the substrate 8 and the counter-electrode, the boride and glass powders, carrying cations (magnesium ions) in the electro-deposition solution under the effect of the electrical field generated, are attracted towards and deposited on the discharging electrodes. When the pre-set film thickness is reached, the substrate 8 is rinsed to remove unneeded residual powders deposited on the substrate, using e.g., isopropyl alcohol. After rinsing, the substrate 8 is dried at ambient temperature and sintered for melting the low melting glass in the film deposited on the electrode 9 for immobilizing the electro-deposited film 15. The firing temperature is usually 400 to 600° C. depending on characteristics of the low melting glass. The sintering atmosphere may be atmospheric air, inert gases or vacuum. For evading oxidation o the electro-deposited film 15, the inert gas or vacuum is preferred. The plasma addressed display apparatus, thus prepared, was put to a durability test to check for changes in the plasma discharging characteristics with lapse of time. The results of the durability test have revealed that the discharging characteristics are stabilized from the initial stage until after lapse of 10,000 hours, with the panel transmittance after lapse of 10,000 hours being 80% or higher. Thus, by coating the discharging electrodes 9 with a protective skin film comprised of electro-deposited boride and low-melting glass particles, the discharging electrodes 9 are improved in durability to lengthen the useful life of the display apparatus.

Then, the intermediate substrate 3, formed of a thin sheet glass, is joined by the frit 11 to the lower substrate 8, as shown in FIG.2C. The space delimited by the lower substrate 8 and the intermediate substrate 3 is delimited by the partitions 10 to constitute the discharging channel 12, in which an ionizable gas is sealed and charged to complete the plasma cell 2.

Finally, the display cell 1 is assembled on the plasma cell 2 to complete the plasma addressed display apparatus, as shown in FIG.2D. The display cell 1 is completed with the upper substrate 4 , the inner surface of which carries the signal electrodes 5. The upper substrate 4 is joined to the intermediate substrate 3 by the sealant 6. As the electro-optical substance 7, liquid crystal, for example, is sealed and charged into a space delimited between the upper substrate.4 and the intermediate substrate 3.

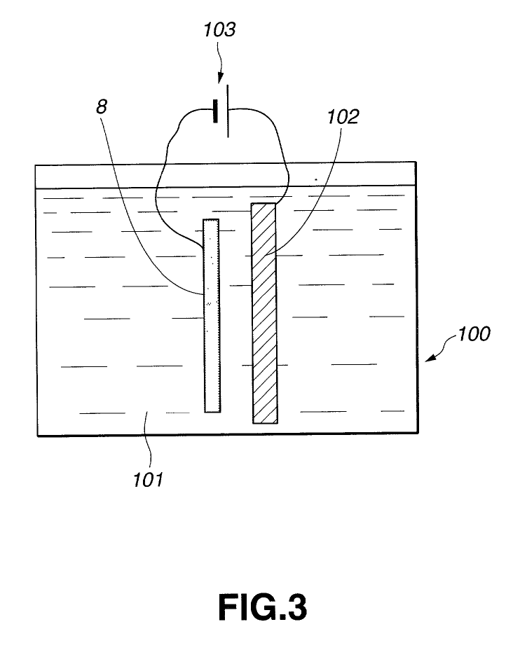

FIG.3 shows a cross-sectional view showing an electro-deposition vessel used in forming the electro-deposition film. As shown therein; the inside of an electro-deposition vessel 100 is filled with an electro-deposition solution 101, and a power source 103 is connected thereacross. The electrode substrate 8 and the counter-electrode 102 serve as the negative electrode and the positive electrode, respectively,., On the side electrode substrate 8, the discharging electrodes operating as the cathodes K. are connected in common and connected to the negative electrode of the power source 103. The power source 103 has an output voltage of, for example, 10 to 50V, with the electrode substrate 8 being maintained at a distance of e.g., 10 mm from the powders forming a protective skin film, were scrutinized. The films of these variable materials were formed by the electro-deposition method on the Ni electrode prepared at the outset by the printing method, and measurements were made of discharging properties in connection with evaluation items of the discharging voltage and discharging stability. The carbon and three borides are superior in discharging properties, whereas the borides, namely GdB₆, LaB₆ and YB₄ exhibit optimum uniform discharging voltage which gives uniform plasma discharging, as may be seen from the following results

| electrode | even | |
|---|---|---|
| material | discharge voltage | discharging state |
| HfC | 430 V | discharging fluctuations, generation |
| | | of arcs |
| ZrC | 441 V | discharging fluctuations, generation |
| | | of arcs |
| TaC | 382 V | localized discharging, even |
| | | discharging not reached |
| LaSrCoO₃ | 500 V | localized discharging, even |
| | | discharging not reached |
| C | 411 V | optimum discharging |
| GdB₆ | 290 V | optimum discharging |
| LaB₆ | 295 V | optimum discharging |
| YB₄ | 260 V | optimum discharging |

Next, an experimentation was conducted for determining a proper range of the particle size of the material. it was found experimentally that the discharging electrodes cannot sufficiently be covered by particles not less than 10 μm. If the electrodeposited particles are excessive in particle size, there is produced a gap such that the particles tend to be peeled off during the rinsing process because the area of adhesion of the particles is small as compared to the coarser particle size. If the mass of the particle is larger, the rate of precipitation is increased to render control difficult. The results of our experiment up to now indicate that the mean particle size of 1 to 3 μm is most appropriate for electro-deposition. Our experiment indicated that an optimum result is obtained if the boride powders and the low melting glass powders are of a mean particle size of 1 to 3 μm and are of the same order of magnitudes. If the particle size of the boride powders and the low melting glass powders differs significantly from each other, the composition of the electro-deposition solution tends to be inconsistent with that of the electro-deposited film.

As for the mixing ratio of the electrically conductive powders and the glass powders, an experiment was conducted as the ratio of GdB₆ and the glass powders was set to 3:1, 3:2 and 1:1. As a result, it was confirmed that the larger the glass proportion, the higher is the bonding power of the electro-deposited film and hence the higher the strength. As for the electrical conductivity of the film, the larger the proportion of the boride powders, the lower may be the resistance value. It was thus found that the electrically conductive powders and the glass powders should preferably be mixed at a volumetric ratio of 9:1 to 3:7. If the proportion of the electrically conductive powders is increased beyond this range, the bonding properties of the electro-deposited film itself are lowered. On the other hand, if the proportion of the glass powders is increased beyond this range, the electrical conductivity is lost.

The thickness of the electro-deposited film affects discharging characteristics and the useful life of the panel significantly. The film thickness as initially required should be set depending on the electrode coating characteristics and discharging characteristics. Empirically, the film thickness appears to be increased with a larger, particle size of the borides. Qualitatively, a certain thickness may be required in order to stop the gap to cover the electrode with coarser particles. However, if the thickness is increased, the number of contact points of the particles is increased, so that the resistance along the thickness tends to be increased. A practically desirable film thickness is of the order of 1 to 20 μm. If the film thickness is smaller than 1 μm, coating difficulties are encountered. On the other hand, if the film thickness is thicker than 20 μm, the electrical resistance is increased excessively. The thickness of the electro-deposited film is preferably controlled to be in a range from 3 to 10 μm.

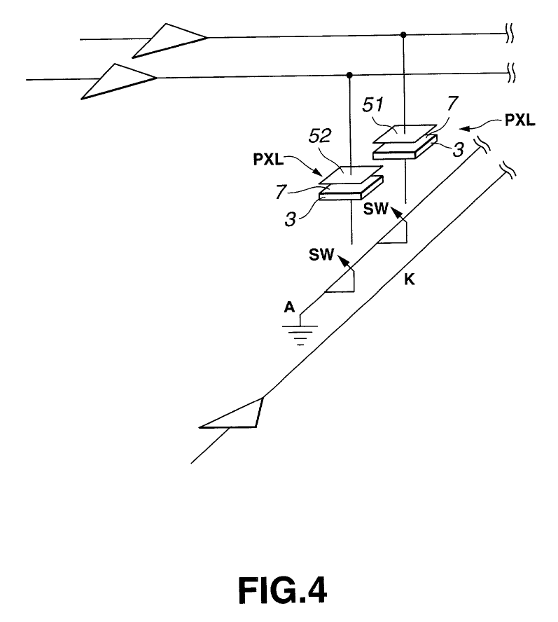

Referring to FIG. 4, the operation of the plasma addressed display apparatus is explained briefly for reference sake. In the drawing, only two signal electrodes 51, 52, one cathode K and one anode A are shown. Each pixel PXL is of a layered structure of the signal electrodes 51, 52, electro-optical substance 7, intermediate substrate 3 and discharging channels. During the plasma discharge, the discharging channels are connected to substantially the anode potential. If picture signals are applied to the pixels in this state, electrical charges are implanted on the electro-optical substance 7 and the intermediate substrate 3. On the other hand, when the plasma discharge comes to a close, the discharging channels revert to the insulated state, so that a floating potential is set and the electrical charges implanted are held in each pixel PXL by way of a so-called sample-holding operation. Since the discharging channels operate as respective sampling switch element provided in each pixel PXL, the discharging channels are schematically represented by a switch symbol SW. On the other hand, the electro-optical substance 7 and the intermediate substrate 3, held between the signal electrodes 51, 52 and the discharging channels, operate as sampling capacitors. When the sampling switch SW is turned on by line sequential scanning, picture signals are held by the sampling capacitor so that the respective pixels are turned on or off depending on the signal level. The signal voltage is held by the sampling capacitor, even after the sampling switch SW is turned off, to permit the active matrix operation of the display apparatus.

What is claimed is:

1. A display apparatus having a pair of substrates connected to each other via a pre-set gap to delimit a hermetically sealed space therebetween, an ionizable gas charged into said space, and an electrode formed on at least one of said substrates to ionize said gas to incur discharging in said space, said electrode being coated by a protective skin film formed by an electro-deposition method, said protective skin film being an electro-deposited and sintered mixture of electrically conductive powders including powders of a boride or carbon and glass powders; wherein
said protective skin film is electro-deposited by a suspension formed on dispersing said electrically conductive powders and said glass powders in a solvent and also, on dissolving an ionic material therein; and wherein
said electrically conductive powders and the glass powders are of a mean particle size not larger than 10 μm.

2. A display apparatus having a pair of substrates connected to each other via a pre-set gap to delimit a hermetically sealed space therebetween, an ionizable gas charged into said space, and an electrode formed on at least one of said substrates to ionize said gas to incur discharging in said space, said electrode being coated by a protective skin film formed by an electro-deposition method, said protective skin film being an electro-deposited and sintered mixture of electrically conductive powders including powders of a boride or carbon and glass powders; wherein
said protective skin film is electro-deposited by a suspension formed on dispersing said electrically conductive powders and said glass powders in a solvent and also on dissolving an ionic material therein; and wherein
said electrically conductive powders and the glass powders are of a mean particle size ranging between 1 and 3 μm.

3. A display apparatus having a pair of substrates connected to each other via a pre-set gap to delimit a hermetically sealed space therebetween, an ionizable gas charged into said space, and an electrode formed on at least one of said substrates to ionize said gas to incur discharging in said space, said electrode being coated by a protective skin film formed by an electro-deposition method, said protective skin film being an electro-deposited and sintered mixture of electrically conductive powders including powders of a boride or carbon and glass powders; wherein
said protective skin film is electro-deposited by a suspension formed on dispersing said electrically conductive powders and said glass powders in a solvent and also on dissolving an ionic material therein; and wherein,
said electrically conductive powders and the glass powders are mixed in a volumetric ratio of from 9:1 to 3:7.

4. A display apparatus having a pair of substrates connected to each other via a pre-set gap to delimit a hermetically sealed space therebetween, an ionizable gas charged into said space, and an electrode formed on at least one of said substrates to ionize said gas to incur discharging in said space, said electrode being coated by a protective skin film formed by an electro-deposition method, said protective skin film being an electro-deposited and sintered mixture of electrically conductive powders including powders of a boride or carbon and glass powders; wherein
said protective skin film is electro-deposited by a suspension formed on dispersing said electrically conductive powders and said glass powders in a solvent and also on dissolving an ionic material therein; and wherein
said protective skin film has a film thickness ranging between 1 and 20 μm.

5. A method for producing a display apparatus having a pair of substrates connected to each other via a pre-set gap to delimit a hermetically sealed space therebetween, an ionizable gas charged into said space, and an electrode formed on at least one of said substrates to ionize said gas to incur discharging in said space; wherein
for forming an electrode on said substrate, then electro-depositing and sintering a mixture of electrically conductive powders including powders of a boride or carbon and glass powders to coat the electrode with a protective skin film to protect said electrode from a shock by an ionized gas,
said protective skin film is electro-deposited by a suspension formed on dispersing said electrically conductive powders and said glass powders in a solvent and also on dissolving an ionic material therein; and wherein
said electrically conductive powders and the glass powders of a mean particle size not larger than 10 μm are used.

6. A method for producing a display apparatus having a pair of substrates connected to each other via a pre-set gap to delimit a hermetically sealed space therebetween, an ionizable gas charged into said space, and an electrode formed on at least one of said substrates to ionize said gas to incur discharging in said space; wherein
for forming an electrode on said substrate, then electro-depositing and sintering a mixture of electrically conductive powders including powders of a boride or carbon and glass powders to coat the electrode with a protective skin film to protect said electrode from a shock by an ionized gas,
said protective skin film is electro-deposited by a suspension formed on dispersing said electrically conductive powders and said glass powders in a solvent and also on dissolving an ionic material therein; and wherein
said electrically conductive powders and the glass powders of a mean particle size ranging between 1 and 3 μm are used.

7. A method for producing a display apparatus having a pair of substrates connected to each other via a pre-set gap to delimit a hermetically sealed space there between, an ionizable gas charged into said space, and an electrode formed on at least one of said substrates to ionize said gas to incur discharging in said space; wherein
for forming an electrode on said substrate, then electro-depositing and sintering a mixture of electrically conductive powders including powders of a boride or carbon and glass powders to coat the electrode with a protective skin film to protect said electrode from a shock by an ionized gas,
said protective skin film is electro-deposited by a suspension formed on dispersing said electrically conductive powders and said glass powders in a solvent and also on dissolving an ionic material therein; and wherein
said electrically conductive powders and the glass powders are mixed in a volumetric ratio of from 9:1 to 3:7.

8. A method for producing a display apparatus having a pair of substrates connected to each other via a pre-set gap to delimit a hermetically sealed space therebetween, an ionizable gas charged into said space, and an electrode formed on at least one of said substrates to ionize said gas to incur discharging in said space; wherein
for forming an electrode on said substrate, then electro-depositing and sintering a mixture of electrically conductive powders including powders of a boride or carbon and glass powders to coat the electrode with a protective skin film to protect said electrode from a shock by an ionized gas,
said protective skin film is electro-deposited by a suspension formed on dispersing said electrically conductive powders and said glass powders in a solvent and also on dissolving an ionic material therein; and wherein
said protective skin film has a film thickness ranging between 1 and 20 μm.

9. A display apparatus having a flat panel structure comprised of a display cell and a plasma cell stacked together via an intermediate substrate;
said display cell having an upper substrate connected to said intermediate substrate via a pre-set gap, an electro-optical substance held in said gap and a plurality of signal electrodes formed in columns on said upper substrate so that picture signals will be applied thereto;
said plasma cell including a lower substrate connected to said intermediate substrate via a pre-set gap to delimit a hermetically sealed space therebetween, an ionizable gas charged in said space, and a scanning electrode formed on said lower substrate to ionize said gas to incur discharging in said space;
said scanning electrode being coated by a protective skin film formed by an electro-deposition method, said protective skin film being an electro-deposited and sintered mixture of electrically conductive powders including powders of a boride or carbon and glass powders;
said scanning electrode being sequentially scanned to write picture signals applied to said signal electrodes on said electro-optical substance; wherein
said protective skin film is electro-deposited by a suspension formed on dispersing said electrically conductive powders and said glass powders in a solvent and also on dissolving an ionic material therein; and wherein
said electrically conductive powders and the glass powders are of a mean particle size not larger than 10 μm.

10. A display apparatus having a flat panel structure comprised of a display cell and a plasma cell stacked together via an intermediate substrate;
said display cell having an upper substrate connected to said intermediate substrate via a pre-set gap, an electro-optical substance held in said gap and a plurality of signal electrodes formed in columns on said upper substrate so that picture signals will be applied thereto;
said plasma cell including a lower substrate connected to said intermediate substrate via a pre-set gap to delimit a hermetically sealed space therebetween, an ionizable gas charged in said space, and a scanning electrode formed on said lower substrate to ionize said gas to incur discharging in said space;
said scanning electrode being coated by a protective skin film formed by an electro-deposition method, said protective skin film being an electro-deposited and sintered mixture of electrically conductive powders including powders of a boride or carbon and glass powders;
said scanning electrode being sequentially scanned to write picture signals applied to said signal electrodes on said electro-optical substance; wherein
said protective skin film is electro-deposited by a suspension formed on dispersing said electrically conductive powders and said glass powders in a solvent and also on dissolving an ionic material therein; and wherein
said electrically conductive powders and the glass powders are of a mean particle size ranging between 1 and 3 μm.

11. A display apparatus having a flat panel structure comprised of a display cell and a plasma cell stacked together via an intermediate substrate;
said display cell having an upper substrate connected to said intermediate substrate via a pre-set gap, an electro-optical substance held in said gap and a plurality of signal electrodes formed in columns on said upper substrate so that picture signals will be applied thereto;
said plasma cell including a lower substrate connected to said intermediate substrate via a pre-set gap to delimit a hermetically sealed space therebetween, an ionizable gas charged in said space, and a scanning electrode formed on said lower substrate to ionize said gas to incur discharging in said space;
said scanning electrode being coated by a protective skin film formed by an electro-deposition method,, said protective skin film being an electro-deposited and sintered mixture of electrically conductive powders including powders of a boride or carbon and glass powders;
said scanning electrode being sequentially scanned to write picture signals applied to said signal electrodes on said electro-optical substance; wherein
said protective skin film is electro-deposited by a suspension formed on dispersing said electrically conductive powders and said glass powders in a solvent and also on dissolving an ionic material therein; and wherein
said electrically conductive powders and the glass powders are mixed in a volumetric ratio of from 9:1 to 3:7.

12. A display apparatus having a flat panel structure comprised of a display cell and a plasma cell stacked together via an intermediate substrate;
said display cell having an upper substrate connected to said intermediate substrate via a pre-set gap, an electro-optical substance held in said gap and a plurality of signal electrodes formed in columns on said upper substrate so that picture signals will be applied thereto;
said plasma cell including a lower substrate connected to said intermediate substrate via a pre-set gap to delimit a hermetically sealed space therebetween, an ionizable gas charged in said space, and a scanning electrode formed on said lower substrate to ionize said gas to incur discharging in said space;
said scanning electrode being coated by a protective skin film formed by an electro-deposition method, said protective skin film being an electro-deposited and sintered mixture of electrically conductive powders including powders of a boride or carbon and glass powders;
said scanning electrode being sequentially scanned to write picture signals applied to said signal electrodes on said electro-optical substance; wherein
said protective skin film is electro-deposited by a suspension formed on dispersing said electrically conductive powders and said glass powders in a solvent and also on dissolving an ionic material therein; and wherein
said protective skin film has a film thickness ranging between 1 and 20 μm.
